(19) United States
(12) Patent Application Publication
(10) Pub. No.: US 2013/0282440 A1
(43) Pub. Date: Oct. 24, 2013

(54) SOCIAL PRICING FOR GOODS OR SERVICES

(71) Applicant: Roger D. ISAAC, San Jose, CA (US)

(72) Inventor: Roger D. ISAAC, San Jose, CA (US)

(21) Appl. No.: 13/539,467

(22) Filed: Jul. 1, 2012

Related U.S. Application Data
(60) Provisional application No. 61/636,958, filed on Apr. 23, 2012.

(51) Int. Cl. G06Q 30/02

(52) U.S. Cl. 705/7.35

(57) ABSTRACT

At a high-level, a novel pricing technique is dependent in part on the influence of followers or friends on one or more internet social site that a user has.

### CROSS-REFERENCE TO RELATED APPLICATIONS

This application claims the benefit of priority of U.S. Prov. App. No. 61/636,958, filed Apr. 23, 2012, entitled METHOD FOR SOCIAL PRICING FOR GOODS OR SERVICES, by Roger D. Isaac, the contents of which are hereby incorporated by reference in their entirety.

### FIELD OF THE INVENTION

The invention relates generally to social networking, and more specifically, to adjusting prices based on a social network of a customer.

### BACKGROUND OF THE INVENTION

Sales of goods or services have traditionally been driven by TV, radio, print, internet, and other means of advertisements. As more and more people move away from using TV, radio, and print, many of the traditional advertising means have had less and less of an impact on sales. Furthermore, conventional technique of macro-marketing and macro-advertising is sometimes provides a low yield of hits relative to a number of people targeted. The Internet has opened up opportunities for non-traditional means of advertisement and sales, such as EBay, Amazon, Facebook, Google, Twitter, YouTube, and Groupon.

These opportunities for advertisement and sales have resulted in a variety of innovations. Gorilla marketing through the use of YouTube videos, posting advertisements through popular feeds, Internet search based advertisement, and other means are now common forms of advertisement and sales. However, as more and more users rely more heavily on the influence of their peer groups (through Twitter, Facebook, and Google+), the revenue, advertisement, and sales opportunities have diminished even in the new media.

What is needed is a new form of advertisement, pricing, and sales that takes advantages of and information from the socially connected Internet. The technique should adjust a price based on a social network influence of a customer.

### SUMMARY

To meet the above-described needs, methods, computer program products, and systems to adjust a price based on a social network influence of a customer. Influence can include just a number of contacts, or other additional factors.

At a high-level, a novel pricing technique is dependent in part on the number of followers or friends on one or more internet social site that a user has.

Nearly all users of the internet have an account and Followers or Friends on a social networking site, such as Twitter, Google+, Facebook, and others. Each of these users have a number or Friends or Followers that are within their social network. Some users, such as celebrities, may have many more Friends and Followers than most individuals. The number of Friends or Followers can serve as a proxy to how popular or how much influence an individual user or group of users have. The more influence a given user has, the more effective targeted advertising through this user is likely to be. When an influential person or group of persons purchases a product or service, this purchase can influence their Followers or Friends by the choices that they make. The most influential users can be rewarded for these purchases through the use of discounts or other incentives in exchange for publishing this information to their Followers or Friends. Users with more Followers or Friends are likely to be more influential than other users with fewer Friends or Followers.

In one embodiment of this invention, when an individual makes a purchase at a retail location, an Internet store, via telephone, or other means, the individual has an option on whether or not to make this information available to their social networks. Allowing this information to be made available to their social networks results in a discount or some other form of incentive to the individual based on a number of criteria. The criteria may include the number of Friends or Followers that the individual has, the activity level of their Friends or Followers, their influence over these Friends or Followers, the fame or notoriety of the individual, their individual purchase history, the purchase history of their Friends or Followers, the purchase history settings of their Friends and Followers, and the likelihood that their Friends or Followers may make similar purchases.

In another element of this invention, the Followers or Friends of individuals may choose to display purchase histories of one or more of their Friends or people that they are following. The purchase histories that are displayed may be displayed based on a number of factors, such as: purchase history user settings, purchase history follower settings, advertisement money paid by the promoters of goods or services, current search trends, follower search history, user search history, follower click history, user click history, follower purchase history, user purchase history, the users geographic location, the users age, and a relative weighting of the their Friends or people that they are following. This relative weighting may be based in part on the click history, the amount of time a user or follower has spent on a given profile, the fame or notoriety of individuals, current search trends, etc.

In another element of this invention, when a user searches for goods or services, the search results are based in part on the purchase history of the users that they are following or Friends with. The search results may be weighted by, but are not limited to advertisement money paid by promoters of goods or services, the number of Friends or Followers of the users Friends or Followers, the relative weighting of the users Friends and Followers, the users search history, the users click history, the users purchase history, the users Followers or Friends purchase history, the users geographic location, the users age, the users gender, the users Followers or Friends geographic location, the users Followers or Friends age, the users Followers or Friends gender, and user settings.

In another element of this invention, users may be associated with their Friends, Followers, or users that they follow based on their purchase history, their Friends and Followers purchase history, and users that they follow purchase history. This information may be aggregated and used to promote goods or services to an individual based on these associations. For instance, a group of users may tend to have similar purchase histories and these users may tend to buy similar goods or services. A product that is popular with some of these individuals may also be popular with other members of the same group. This information can then be input into an algorithm to determine the displayed purchase history for the Friends or Followers of an individual. This information can also be used to determine the results of goods or services searches for individuals.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system to adjust pricing based on a social network of a customer, according to one embodiment.

FIG. 2 is a more detailed block diagram illustrating an online retailer of the system of FIG. 1, according to one embodiment.

FIG. 3 is a more detailed block diagram illustrating a purchase information server of the system of FIG. 1, according to one embodiment.

FIG. 4 is a flow diagram illustrating a method for adjusting pricing based on a social network of a customer, according to one embodiment.

FIG. 5 is a more detailed flow diagram illustrating a method for determining a social networking influence of the customer of the method of FIG. 4, according to one embodiment.

FIG. 6 is a block diagram illustrating an exemplary computing device, according to one embodiment.

### DETAILED DESCRIPTION

The present invention provides methods, computer program products, and systems to adjust pricing based on a social network of a customer. At a high-level, a customer's influence as it relates to social networking can result in price breaks during online shopping. In exchange, the purchase may be posted to social networks.

As referred to herein, a social networking influence can be represented as a value that characterizes at least the quantity and/or quality of contacts in social networks. In some embodiments, only a number of followers is considered. In other embodiments, other factors such as a purchase history of those followers is also considered. Numerous variations are possible, as detailed herein.

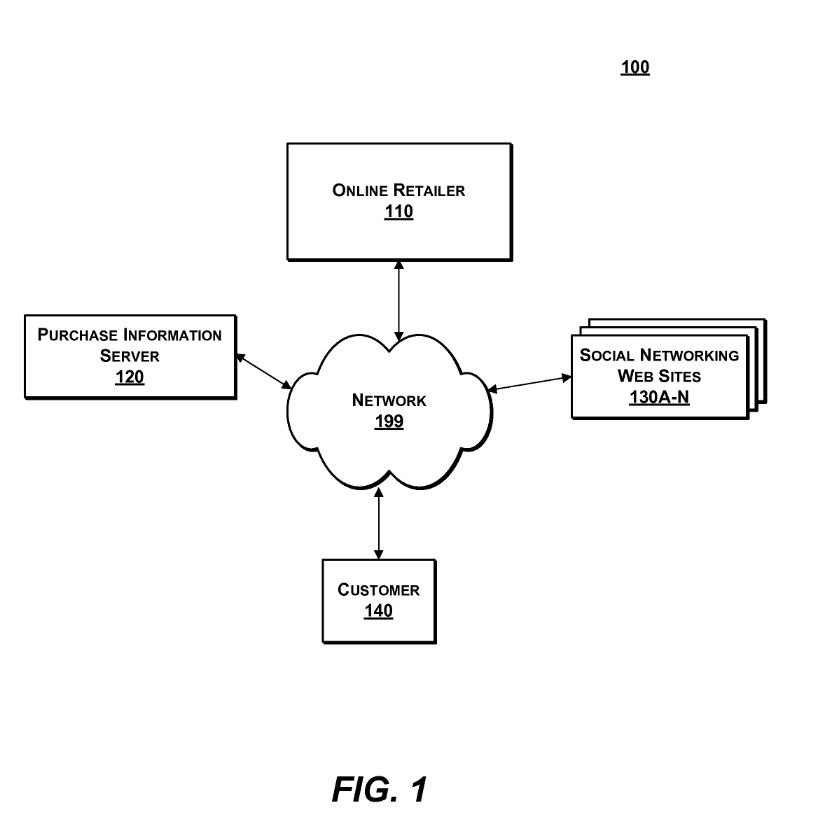

FIG. 1—Adjustment System 100

FIG. 1 is a high-level block diagram illustrating a system 100 to adjust pricing based on a social network of a customer, according to one embodiment. In one embodiment, the system 100 adjusts pricing based on a measure of the customer's influence within social networks. The system comprises an online retailer 110, a purchase information server 120, social networking web sites 130A-N, and a customer 140. The components can be coupled to a network 199, such as the Internet, a local network or a cellular network, through any suitable wired (e.g., Ethernet) or wireless (e.g., Wi-Fi or 3G) medium, or combination. Other embodiments of communication channels are possible, including hybrid networks. Additional network components can also be part of the system 100, such as firewalls, virus scanners, routers, switches, application servers, databases, and the like.

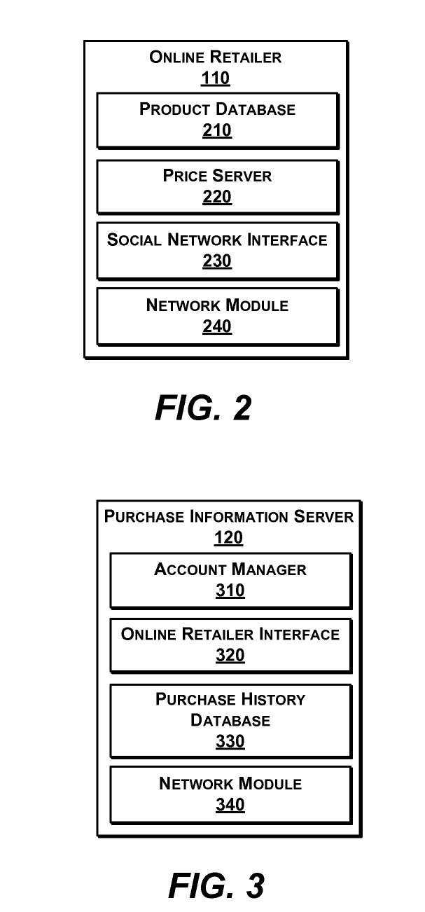

The online retailer 110 can be any online entity selling products or services. Examples include Google, Yahoo! Shopping, EBay, Amazon, and the like. The online entity 110 can be a virtual storefront or a brick and mortar store. Also, the online entity 110 can provide services other than shopping (e.g., social networking or Internet searching). The online retailer 110 can include a server, or a cluster of distributed servers, a host, a personal computer, a server blade, a networked cash register, or any other computing device. In one embodiment, the customer 140 reaches the online retailer 110 with a domain name for a web site. Individual web pages under the domain name can be dynamically generated to show a product, a price, photos, descriptions, and other information associated with the product. Note that the disclosure herein often refers to just a product, but it is understood that in many cases, a service can be substituted. Specific embodiments of the online retailer 110 are discussed below with respect to FIG. 2.

The purchase information server 120 can be a third-party entity providing a service to the online retailer 110. Alternatively, the purchase information server 120 can be controlled by the online retailer 110, and as a result, deeply integrated with the hardware and software used for customer shopping on the online retailer 110 (for example, logon information can be the same). More detailed embodiments of the purchase information server 120 are discussed below in association with FIG. 3.

The social networking web sites 130A-N can be any social network such as Facebook, MySpace, LinkedIn, and the like. The customer 140 can have a user profile on one or more of the social networking web sites 130A-N which can detail one or more of friends, friends of friends, followers, or other social connections who the customer 140 is following or is friending, and group pages. Additional relevant information that can be associated with the profile includes purchase history, interests, likes, and status.

In some implementations, social networking can be peripheral to the main purpose of a web site. For example, Pandora is a music service that offers some social networking, and thus, could be considered a social networking web site for the purposes of this disclosure. Further, the social networking websites 130A-N are implemented by a server, or a cluster of distributed servers, software applications, or any of the other appropriate computing devices discussed herein.

The customer 140 may use a mobile or stationary computing device that allows a consumer to shop online, and otherwise make use of the Internet. The customer 140 can be shopping online or be physically present at a store. The consumer is preferably a member of social networks. Some of those social networks, such as Facebook, are based on sharing various experiences with friends through a news feed. Besides people that a consumer actually has a personal relationship, friends can also include Internet-exclusive relationships, corporate entities, interest pages, and the like. Other of those social networks, such as Twitter and Instagram, are based on who a consumer is following, and followers of the consumer.

FIG. 2—Online Retailer 110

FIG. 2 is a more detailed block diagram illustrating an online retailer 110 of the system 100 of FIG. 1, according to one embodiment. The online retailer 120 includes a product database 210, a price server 220, a social network interface 230, and a network module 240. The components can be implemented in hardware, software, or a combination of both.

The product database 210 stores records of products offered by the online retailer 110. A price or price information is stored for reach product as a baseline, or regular price. Quantity, photographs, specifications, and customer reviews can also be part of a product record. A customer with no or insufficient social networking influence can be presented regular pricing. Each record may also include global settings or regional settings that affect price adjustments (e.g., settings applied to all new products of a certain account).

The price server 220 determines whether a price modification will be made, and if so, an amount of the adjustment. Specifically, the price server 220 implements an algorithm to calculate an influence value. In some embodiments, the price server 220 makes the determination (or update) in substantially real-time with a transaction (e.g., at check out). In other embodiments, the price sever 220 accesses pre-processed information from, for example, the purchase information server 120. The information from the purchase information server 120 can include a price adjustment, or information used by the price server 220 to determine a price adjustment.

The social network interface 230 allows social networking information to be extracted from social networking web sites. In one implementation, logon credentials are provided by a customer so that the social network interface 230 can access a social network account for the customer to gather information related to the customer's influence. In another implementation, the social networking interface 230 passively extracts information (i.e., without logon credentials). For example, public information on a Facebook profile can be accessed. In an embodiment, the social network interface 230 can also access Facebook profiles of friends, Twitter pages of followers and pages of who the customer is following, and the like.

The network module 240 provides a communication network with devices on the network 199. A NIC (network interface card) device or wireless cards allow physical connections to a communication medium. A higher-level application or device can implement networking protocols such as IEEE 802.11. Further, a user application such as a browser, a client, or a daemon interfaces with the network module 240 to display network communications and to receive user input.

FIG. 3—Purchase Information Server 120

FIG. 3 is a more detailed block diagram illustrating a purchase information server 120 of the system 100 of FIG. 1, according to one embodiment. The purchase information server 120 includes an account manager 310, an online retailer interface 320, a purchase history database 330, and a network module 340. In some implementations, the purchase information server 120 also includes the social network interface 230 of FIG. 2.

The account manager 310 is an optional component that tracks customers. In one example, customers each have unique logon credentials. Universal credentials systems can use credentials from cloud-based applications, such as Facebook. The universal credentials provide simultaneous access to the Facebook social network for exporting information about a customer's contacts.

The online retailer interface 320 provides access to an online retailer for configurations. Global settings and regional settings can be configured. Other rules can be constructed to automatically be considered when calculating a price adjustment.

The purchase history database 330 tracks purchases made by customers. The purchase information can be later used to determine a price adjustment. Purchases can be tracked automatically at POS (point-of-sale) transactions. For example, logon information or other identifying criteria (e.g., name, credit card info, discount card information) identify a customer. A client at the POS can send the customer identification and transaction data automatically.

The network module 340 can be similar to the network module 240 of FIG. 2. The network module 340 manages communications between the purchase information server 120 and external components.

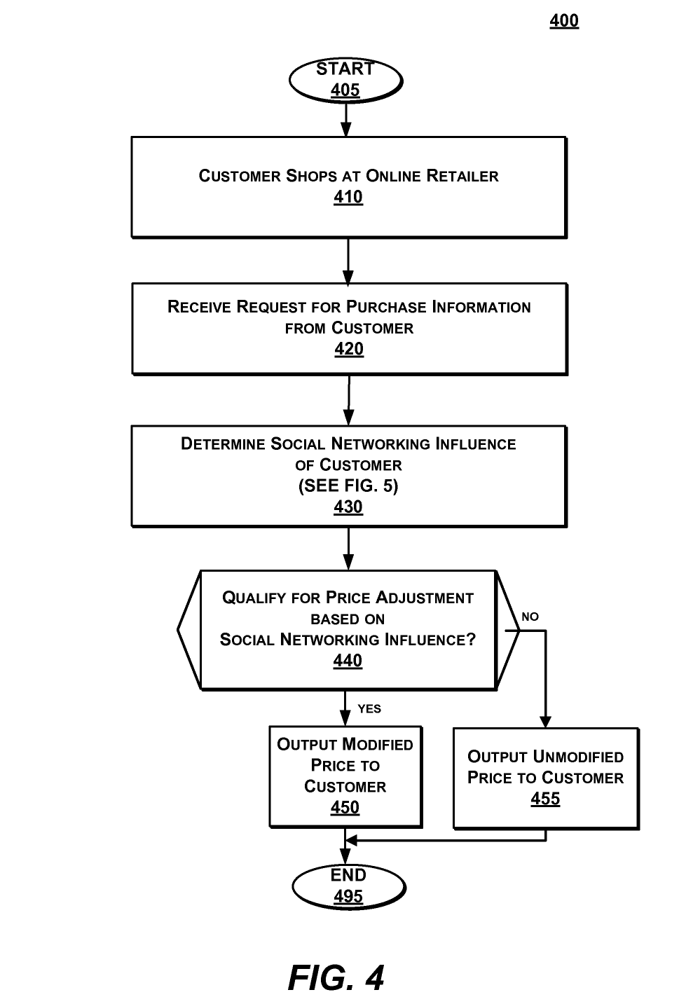

FIG. 4—Adjustment Method 400

FIG. 4 is a flow diagram illustrating a method 400 for adjusting pricing based on a social network of a customer, according to one embodiment.

At step 410, a customer shops at an online retailer or a brick and mortar retailer. The online retailer may be accessed with a URL to a web site. Individual products and prices can be displayed to a customer as a virtual storefront. A price shown on a product page can be a modified price adjusted in accordance with a social networking influence of the customer.

At step 420, a request for purchase information is received from a customer. The request can be responsive to the customer selecting a product web page to view. In other embodiments, the request and provision of price can occur at alternative points of an online transaction. For instance, the request can be responsive to a user selecting a product for a shopping cart, to a user checking out, or to a user that selects new product web pages. The customer surfing away from a product can be lured back with a discount price offing that was adjusted based on a social networking influence.

Alternatively, a customer can be physically present at a check-out register of a brick and mortar store. During check out, the customer is identified (e.g., by telephone number, credit card info, or logon information such as Facebook logon information) and price adjustments are made. Also, while shopping, a customer can scan items in the aisles to get adjusted pricing before going to the check-out register. Products and services can be identified by UPC (Universal Price Code) or other bar code scanning, serial numbers, QR (Quick Response) codes, and the like.

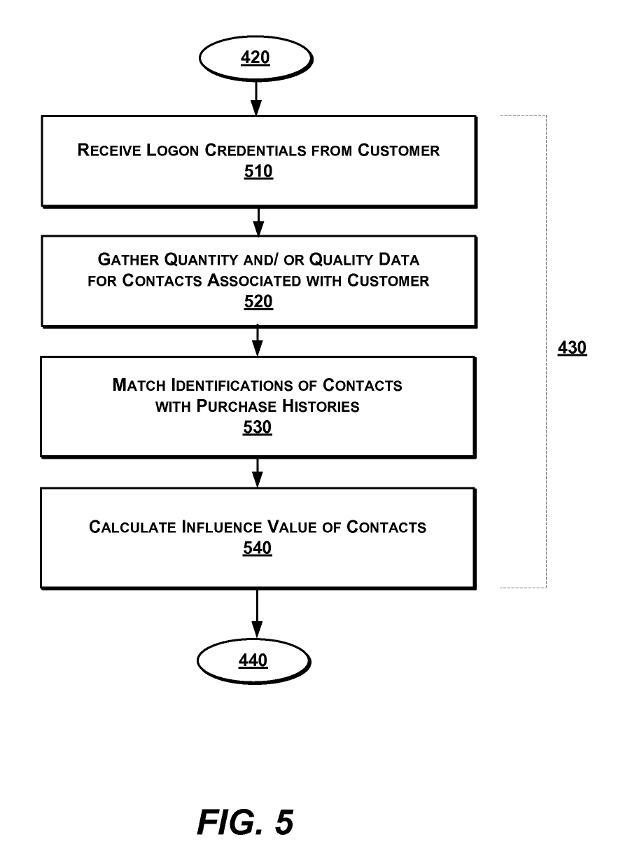

At step 430, a social networking influence of a customer is determined. Generally, a value is determined to represent a social networking influence from factors such as quantity and quality. The individual factors used for influence can vary among implementations. In one embodiment, a number of contacts is a sole factor. A more detailed embodiment of step 430 is discussed below in association with FIG. 5.

At step 440, if a customer qualifies for a price adjustment based on social networking influence, at step 450, a modified price is output to a customer. If a customer does not qualify for a price adjustment, at step 455, an unmodified price is output to a customer. The amount of price adjustment can be derived from an influence value. In one example, the influence value can be used to search an index of influence values and corresponding price adjustments. The price adjustments can be linear, exponential, decaying, random, stepwise, or the like.

The factors used to determine whether a customer qualifies for a price adjustment can be customized for individual implementations. In some cases, a threshold for a value of social networking influence must be surpassed. In other cases, a customer may be required to be a member, or to be logged-on in order to be offered modified pricing. Additionally, a customer's own purchase history can be used to determine modified pricing.

FIG. 5—Influence Method 430

FIG. 5 is a more detailed flow diagram illustrating a method 430 for determining a social networking influence of the customer of the method 400 of FIG. 4, according to one embodiment.

At step 510, logon credentials are received from a customer. The credentials enable direct access to a user profile at a particular social network. If credentials are not provided, public information can be extracted from a user profile. In some embodiments, a purchase information server registers for social networking profiles. By becoming friends of a customer or by following the customer, additional information can be extracted.

At step 520, a quantity and/or quality data of contacts associated with a customer is gathered. For example, a number of Facebook friends is determined.

However, in another example, a quality of the Facebook friends is calculated. The quality can be affected by many factors, such as, how often the users friend(s) or follower(s) shop online, how much money a users friend(s) or follower(s) spent with a particular online retailer, how many friends or followers the users friend(s) or follower(s) have, the geographic location of the customer and/or Facebook friend(s) or follower(s), the age or gender of the user and/or Facebook friend(s) or follower(s), a geographical location, a number of daily visitors to a profile, a number of Tweets, a semantic analysis of text in posts, how frequently a users friend(s) or follower(s) checks the users profile, how often the users friend(s) or follower(s) profile is viewed, the income or resources of a user, the income or resources of a users friend(s) or follower(s), the types of items or services a user purchases, the types or items a user's friend(s) or follower(s) purchase, etc. Factors can also be automatically or manually provided. Many other factors are possible. The quality aspects provide a micro-marketing or micro-advertising approach to identifying a target buying group, as opposed to the traditional macro-marketing or macro-advertising approach.

At step 530, identifications of contacts are matched with purchase histories. Some contacts are also registered customers. Internal access to purchase histories is available for the registered customers. As a result, more detailed information about shopping patterns is made available. The purchase history is direct evidence that can be treated as a more relevant factor affecting the quality of contacts. In one embodiment, invites can be sent to the contacts to register with a purchase information server.

At step 540, an influence value is calculated. The specific algorithm used to determine the influence value is implementation-specific. The factors of an algorithm can be varied, and the weights associated with the factors can be varied as well. In some embodiments, a default algorithm is configured until changed, and in other embodiments, the default algorithm cannot be changed.

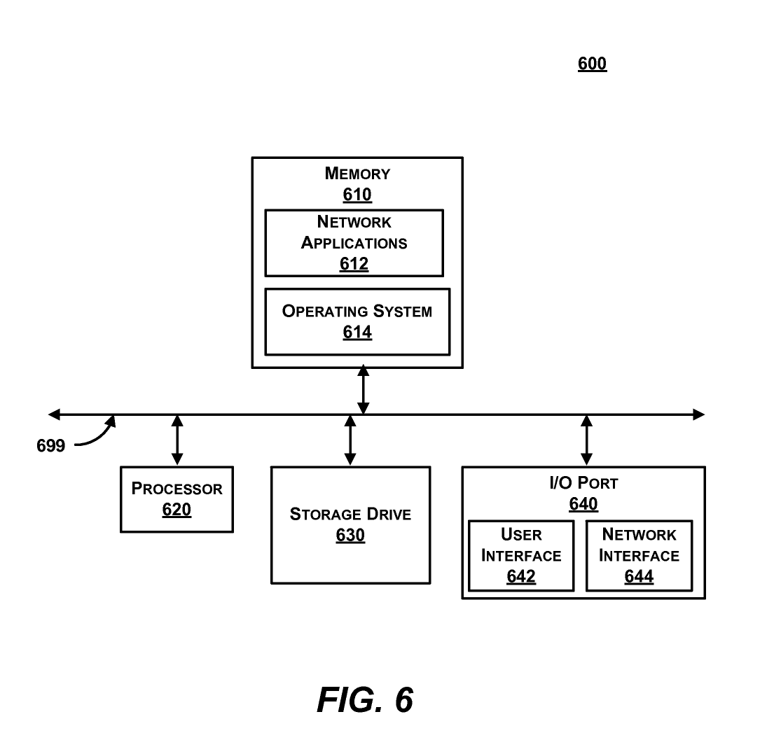

FIG. 6—Computing Device 600

FIG. 6 is a block diagram illustrating an exemplary computing device 600 for use in the system 100 of FIG. 1, according to one embodiment (e.g., the online retailer 110, the purchase information server 120, the social networking web sites 130A-N, or the customer 140). Additionally, the system 100 is merely an example implementation itself, since the system 100 can also be fully or partially implemented with laptop computers, tablet computers, smart cell phones, Internet appliances, and the like.

The computing device 600, of the present embodiment, includes a memory 610, a processor 620, a hard drive 630, and an I/O port 640. Each of the components is coupled for electronic communication via a bus 699. Communication can be digital and/or analog, and use any suitable protocol.

The memory 610 further comprises network applications 612 and an operating system 614. The network applications 612 can include the modules of network applications, access points, or controllers. Other network applications can include a web browser, a mobile application, an application that uses networking, a remote application executing locally, a network protocol application, a network management application, a network routing application, or the like.

The operating system 614 can be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 620 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Atheros, Broadcom, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the storage drive 630

The storage drive 630 can be any non-volatile type of storage such as a magnetic disc, EEPROM, Flash, or the like. The storage drive 630 stores code and data for applications.

The I/O port 640 further comprises a user interface 642 and a network interface 644. The user interface 642 can output to a display device and receive input from, for example, a keyboard. The network interface 644 connects to a medium such as Ethernet or WiFi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Java, JavaScript, PHP, Python, Perl, Ruby, and AJAX. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

Given the above disclosure, one of ordinary skill in the art will recognize that additional implementations are possible, within the spirit of the present invention.

### Additional Embodiments

For example, an Internet search service, such as Google, Bing or some other online retailer, returns product or service results based in part on the purchase history of their Friends or other users that they are following. These results are weighted in part according to the social reach (as determined, for example, by the number of followers or friends or notoriety) of each of these Friends or other users that the user is following.

For an Internet search, the Internet search service queries a purchase information server to determine the purchase history and social reach of the user and individuals and groups in the user's social network (friends, and users or groups that the user is following). The purchase information server then returns results based on this purchase information. This information is then combined with other factors, such as advertising dollars spent for specific search results, the user's click history, current trending searches, and the searches or purchases of other members of the user's social network. The search results are then displayed to the user in an order which is in part based on the reach of the social network of the user's friends, followers, and the people or groups that the user is following.

In another embodiment, advertisements are dynamically tailored to a customer. Price discounts are calculated and presented to a customer based off, for example, purchase history of friends of followers, the users influence on their social network, the number of friends or followers that a user has, terms used in a search query, browsing history, or a user profile.

In another embodiment, product offers may be made directly to customers based on the customers influence on their social network, the customers purchase information history, the purchase history of the customers' friends or followers, the number of friends or followers a user has, browsing history, the age of the user, the gender of a user, the geographic location of a user, the ages of the friends or followers, the genders of the friends or followers, the geographic location of the friends or followers, or a user profile. The product offer pricing is based on the customers social network influence.

In another embodiment, the purchase history or a subset of the purchase history of a user is displayed to the users friends or followers based on the users social networking influence. Additionally, the purchase history of a user may be displayed or not displayed to the users friends or followers based on the friends or followers purchase history, the purchase history of the user, the notoriety of a user, the number of friends or followers that the user has, the browsing history of the friends or followers, the age of the user, the gender of a user, the geographic location of a user, the ages of the friends or followers, the genders of the friends or followers, the geographic location of the friends or followers, and/or the browsing history of the user.

In yet another embodiment, users may be grouped based on their social networking influence, their purchase information history, their search history, the relative number of friends or followers the users have, their geographic location, their age, and/or their gender. Advertisements, product offers, or special discounts may be offered to these groups of users based on their social networking influence.

In still another embodiment, a customer can receive marketing or advertising based on activity with related social networks.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A computer-implemented method for adjusting a price based on a social network of a customer, comprising:
receiving a request for purchase information from the customer, the purchase information being associated with a baseline price for a product or service;
determining an influence of social networking contacts associated with the customer, the influence measured by at least one of quantity and quality of contacts;
calculating a modification to the baseline price on the influence of social networking contacts; and
outputting the modified price to the customer.

2. The method of claim 1, wherein the quality of contacts is based on at least one of:
how often the customers social networking contacts shop online, how much money the customers social networking contacts spent with a particular retailer, the geographic proximity of the customer and the customers social networking contacts, the relation of the age or gender of the customer and the customers social networking contacts, a number of visitors within a given time period to a customers' profile, the customers number of Tweets or posts, a semantic analysis of text in the customers posts or Tweets, how frequently a customers' social networking contacts check the customers profile or the customers Tweets, how often the customers' social networking contacts' profiles are viewed, the income or resources of a customers' social networking contacts, the types of items or services a customers' social networking contacts purchase.

3. The method of claim 1, wherein determining a quantity of social networking contacts comprises:
determining a quantity of friends associated with the customer for at least one social network.

4. The method of claim 1, wherein determining an influence of social networking contacts comprises:
determining a quantity of followers associated with the customer for at least one social network.

5. The method of claim 1, wherein determining an influence of social networking contacts comprises:
determining a quantity of users being followed by the customer for at least one social network.

6. The method of claim 1, wherein determining an influence of social networking contacts comprises:
aggregating associates from more than one social network.

7. The method of claim 1, wherein calculating a modification to the baseline price comprises:
providing a reduction in price that increases with a higher quantity of social networking contacts.

8. The method of claim 1, further comprising:
querying a purchase information server for a purchase history associated with the social networking contacts; and
receiving the purchase history;
wherein calculating a modification to the baseline price comprises calculating the modified price based on the influence of social networking contacts and the social network purchase history.

9. The method of claim 7, wherein calculating a modification to the baseline price comprises:
determining a likelihood that social networking contacts will purchase the product or service, or similar products or services, in the future.

10. The method of claim 1, further comprising:
querying a purchase information server for a purchase history associated with the customer; and
receiving the purchase history;
wherein calculating a modification to the baseline price comprises calculating the modified price based on the influence of social networking contacts and the customer purchase history.

11. The method of claim 1, further comprising:
prior to the purchase, receiving log on information associated with the customer for at least one social network;
querying the at least one social network for information about social networking contacts; and
at the time of purchase, receiving an identification of the customer.

12. The method of claim 1, further comprising:
associating a purchase history of at least one of the social networking contacts with the customer.

13. The method of claim 1, further comprising:
at the time of purchase, receiving log on information associated with the customer for at least one social network; and
querying the at least one social network for information about social networking contacts,
wherein outputting the modified price to the customer occurs at the time of purchase.

14. The method of claim 1, further comprising:
publishing the purchase information on at least one social network.

15. The method of claim 1, further comprising:
making at least one additional purchase offer to the customer based on the quantity of social networking contacts.

16. The method of claim 1, wherein receiving a request purchase information from the customer comprises:
receiving a request for purchase information from the customer making a purchase from at least one of: a retail store, an online store, or a service provider.

17. The method of claim 1, wherein the social networking contacts are associated with at least one of: Facebook, Instagram, Google Circles, MySpace, SoundCloud, and Twitter.

18. A non-transitory computer readable medium for storing instructions, that when executed by a processor, performs a method for adjusting a price based on a social network of a customer, the method comprising:
receiving a request for purchase information from the customer, the purchase information being associated with a baseline price for a product or service;
determining an influence of social networking contacts associated with the customer, the influence measured by at least one of quantity and quality of contacts;
calculating a modification to the baseline price on the influence of social networking contacts; and
outputting the modified price to the customer.

19. A system to adjust a price based on a social network of a customer, comprising:
a communication interface operable to receive a request for purchase information from the customer, the purchase information being associated with a baseline price for a product or service;
a social networking module, coupled in communication with the communication interface, operable to determine an influence of social networking contacts associated with the customer, the influence measured by at least one of quantity and quality of contacts; and
a social pricing module, coupled in communication with the social networking module, operable to calculate a modification to the baseline price on the influence of social networking contacts,
wherein the communication interface is further operable to output the modified price to the customer.
